(19) United States
(12) Patent Application Publication
(10) Pub. No.: US 2010/0010919 A1
(43) Pub. Date: Jan. 14, 2010

(54) System and method to generate a product value

(76) Inventors: William Hudak, Palo Alto, CA (US); Jordan Kobert, San Francisco, CA (US)

Correspondence Address: Jordan Kobert, 262 Frederick St.,, #1, San Francisco, CA, 94117, US

(21) Appl. No.: 12/387,446

(22) Filed: May 1, 2009

Related U.S. Application Data
(60) Provisional application No. 61/054,422, filed on May 19, 2008.

(51) Int. Cl. G06Q 30/00; G06F 17/30; G06F 7/10

(52) U.S. Cl. 705/27; 707/5; 707/E17.109

(57) ABSTRACT

Described herein are systems and methods for generating a product value. In some embodiments, a method for generating a product value includes the steps of receiving a product value request from a user, providing a product value information portal, accumulating product value information, and generating a product value. In some embodiments, a system for generating a product value includes a user interface adapted and configured to receive a product value request from a user for a specified product, a portal adapted and configured to receive value information from a plurality of users for the specified product, and a processor adapted and configured to accumulate product value information and generate a product value.

### CROSS-REFERENCE TO RELATED APPLICATIONS

This application claims priority to U.S. Provisional Application No. 61/054,422, titled “SYSTEM AND METHOD TO GENERATE A PRODUCT VALUE” filed May 19, 2008, which is incorporated by reference herein in its entirety.

In addition, the systems and methods described herein may be applied to any of the devices and systems described in any of the following references. This application may be related to U.S. application Ser. No. 11/682,278, titled “System and Method for Enabling Online Research, Publication, Promotion, and Management of User Goods”, and filed 5 Mar. 2007. This application may also be related to U.S. Provisional Application No. 61/076,995, titled “Systems and Methods to Guarantee a Selling Price of a Product”, filed 30 Jun. 2008, and U.S. Provisional Application No. ______, titled “System and Method to Guarantee A Selling Price of a Product”, filed 7 Apr. 2009. Each of these applications is incorporated by reference herein in its entirety.

### INCORPORATION BY REFERENCE

All publications and patent applications mentioned in this specification are herein incorporated by reference in their entirety as if each individual publication or patent application was specifically and individually indicated to be incorporated by reference.

### TECHNICAL FIELD

This invention relates generally to the ecommerce field, and more specifically to an improved method and system to generate a product value in the ecommerce field.

### SUMMARY OF THE INVENTION

Described herein are systems and methods for generating a product value. In some embodiments, a method for generating a product value includes the steps of receiving a product value request from a user, providing a product value information portal, accumulating product value information, and generating a product value. In some embodiments, a system for generating a product value includes a user interface adapted and configured to receive a product value request from a user for a specified product, a portal adapted and configured to receive value information from a plurality of users for the specified product, and a processor adapted and configured to accumulate product value information and generate a product value.

In some embodiments, the receiving step of the method includes receiving a product value request from a user by the user selecting a product from a list of search results. The receiving step may further include receiving information about the product. The information about the product may include the title of the product, the condition of the product, a description of the product, photos of the product, other suitable product information, and any combination thereof.

In some embodiments, the accumulating step further includes receiving a user estimated value. The user estimated value may be received from a user that is not logged into the system. The step of receiving a user estimated value from a user that is not logged into the system may include the step collecting user estimated values that are entered into an external system.

In some embodiments, the accumulating step further includes receiving a value from a marketplace listing. The value from a marketplace listing may be a value that the product sold for in an historic marketplace listing. The step of receiving a value from a marketplace listing may include the steps of providing multiple marketplace values to a user and receiving selected marketplace values from a user. The step of receiving a value from a marketplace listing may further include calculating an average marketplace value based on the marketplace values selected by the user. In some embodiments, the accumulating step further includes receiving a value from an external site.

In some embodiments, the generating step further includes removing outlying values. The step of removing outlying values may include removing a value that is outside of a predetermined range. In some embodiments, the generating step further includes multiplying a value by a constant. The value of the constant may be determined by the validity of the source of the value. In some embodiments, the source of the value is a user, and the validity of the user is determined by factoring in at least one of feedback on the user from other users in the system, historical accuracy of the user, product category, and number of estimates the user has submitted to the system.

In some embodiments, the generating step further includes generating an average value. In some embodiments, the method further includes the step of creating a marketplace listing.

### BRIEF DESCRIPTION OF THE FIGURES

FIGS. 1A and 1B are flow diagrams of the system and method of a first preferred embodiment of the invention.

FIG. 2 is a flow diagram of the step of generating a product value of the first preferred embodiment of the invention.

FIGS. 3A-3G are drawings of the system of a first preferred embodiment of the invention.

### DETAILED DESCRIPTION

The following description of preferred embodiments of the invention is not intended to limit the invention to these embodiments, but rather to enable any person skilled in the art to make and use this invention.

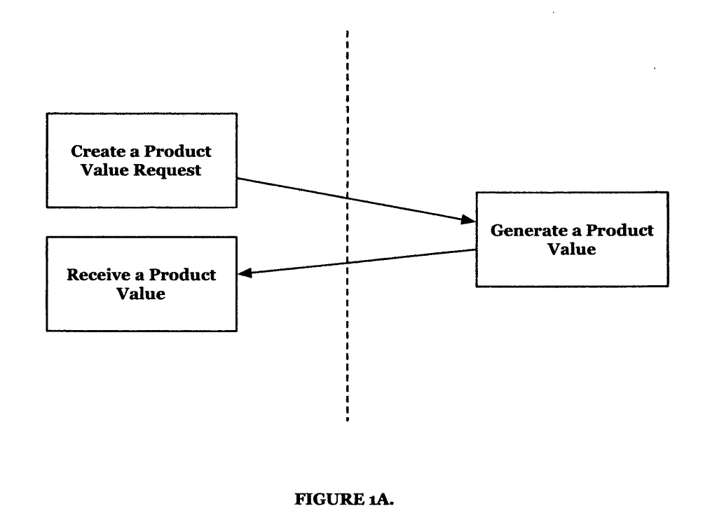

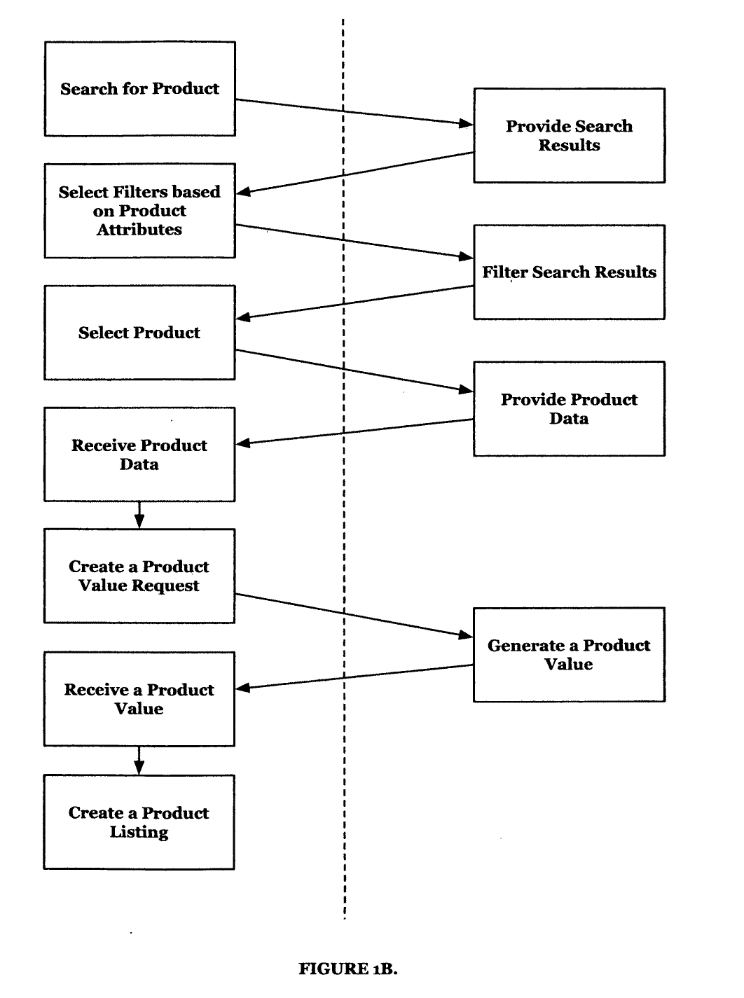

As shown in FIG. 1, the system and method of the preferred embodiments includes the steps of creating a product value request and generating a product value. The system is preferably designed for the ecommerce field and, more specifically, for generating a product value in the ecommerce field. The system is preferably designed to be an interactive pricing guide for products such as digital cameras, cell phones, sporting goods, collectors' items, or any other suitable product. The system preferably evaluates online shopping, marketplace and user-generated data to generate a product value. An informed user (for example, one with a generated product value) may buy, sell, share and/or review other products. The system, however, may be alternatively used in any suitable environment and for any suitable reason.

As shown in FIG. 1B, the method of the preferred embodiments includes the steps of searching for a product, providing search results, selecting filters based on product attributes, filtering search results, selecting a product, providing product data, receiving product data, creating a product value request, generating a product value, receiving a product value, and creating a product listing.

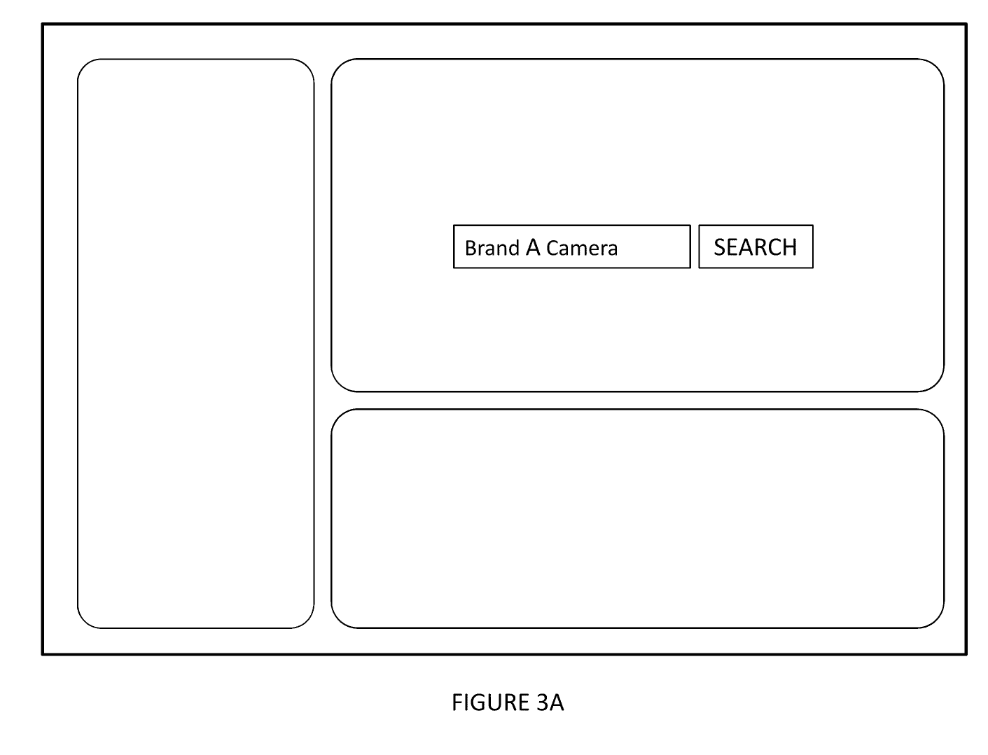

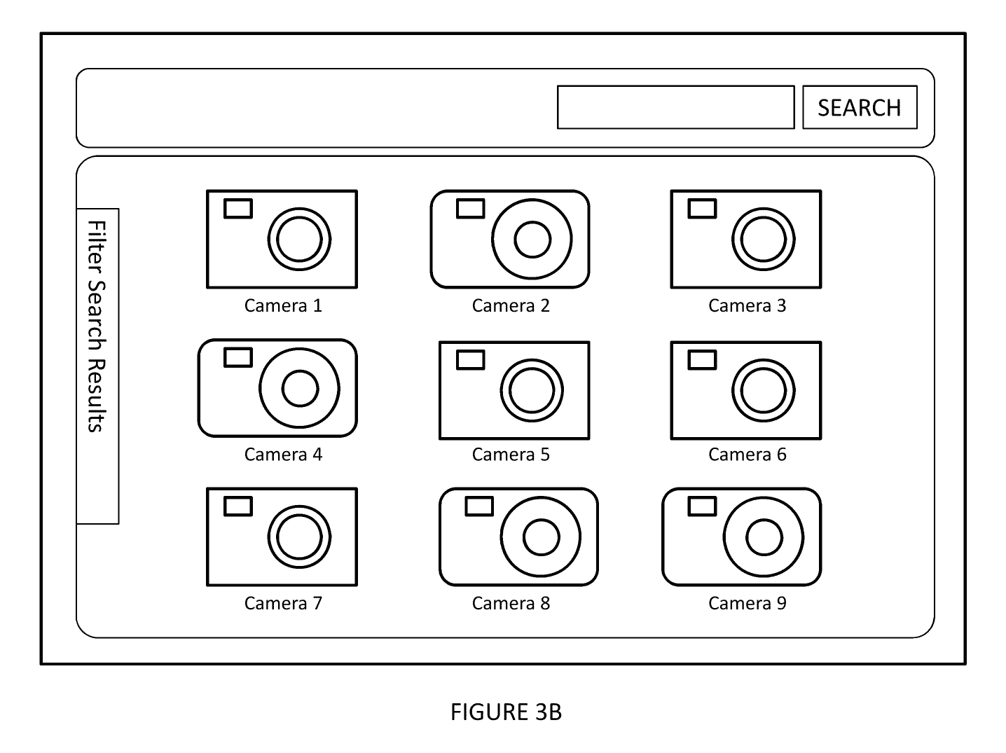

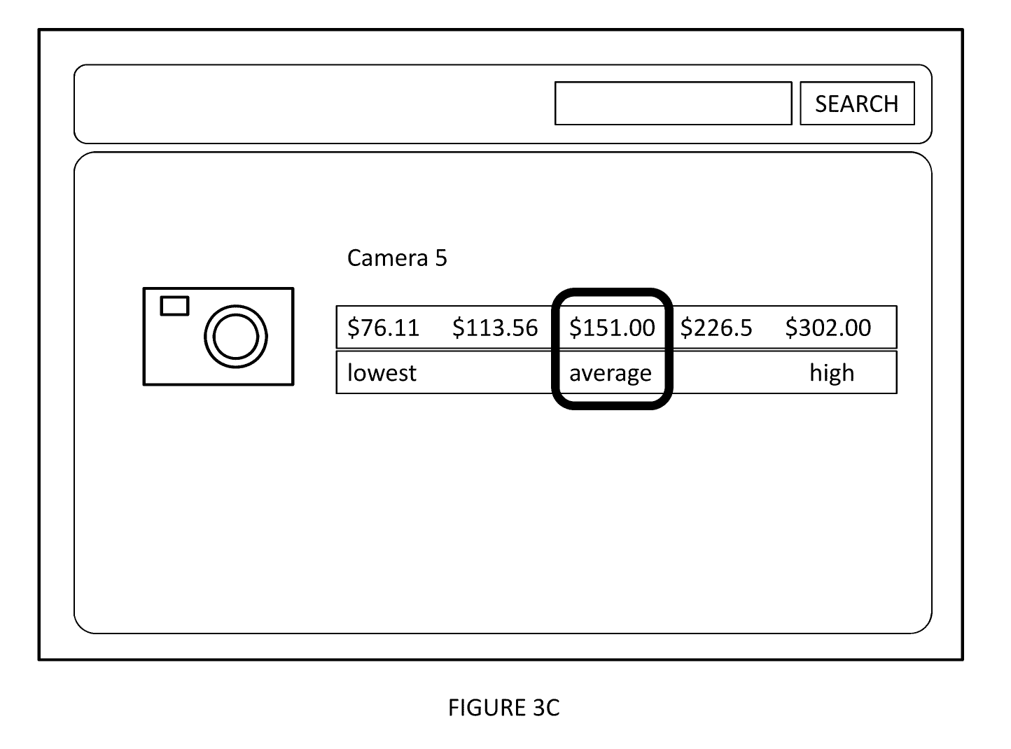

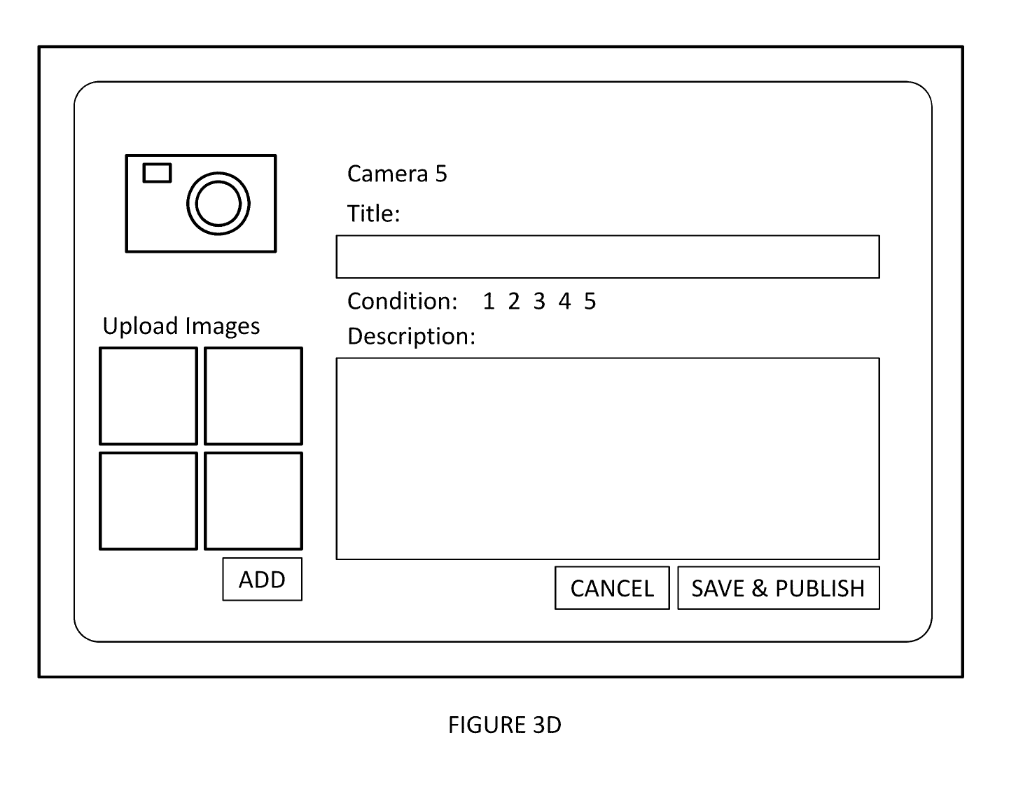

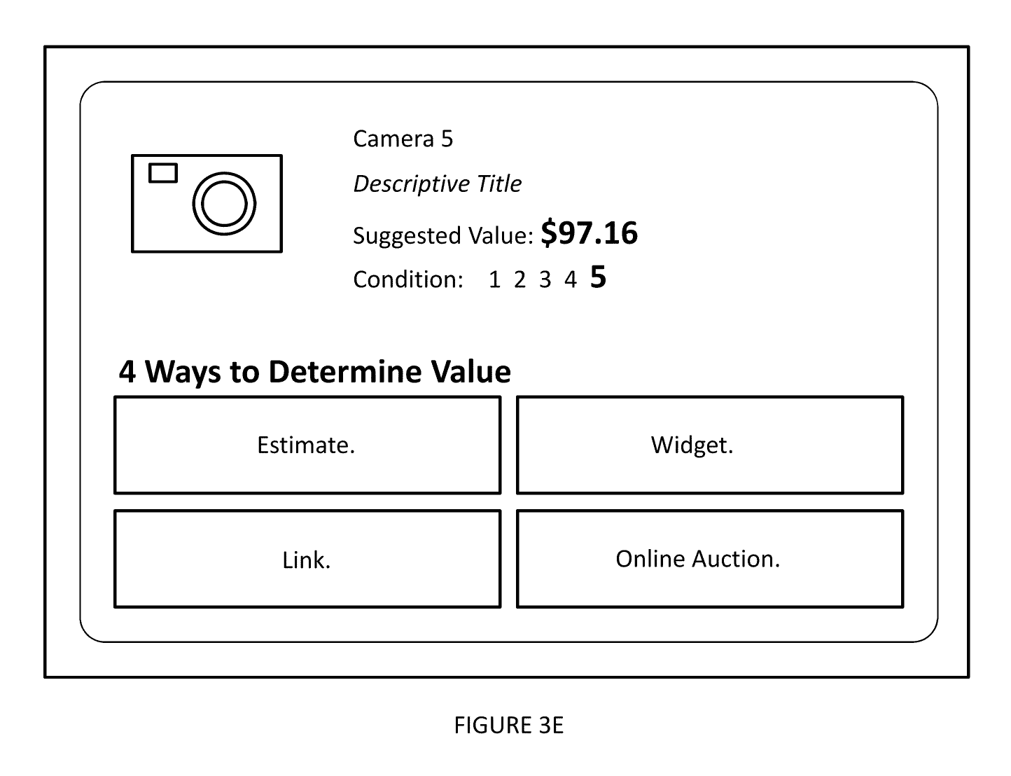

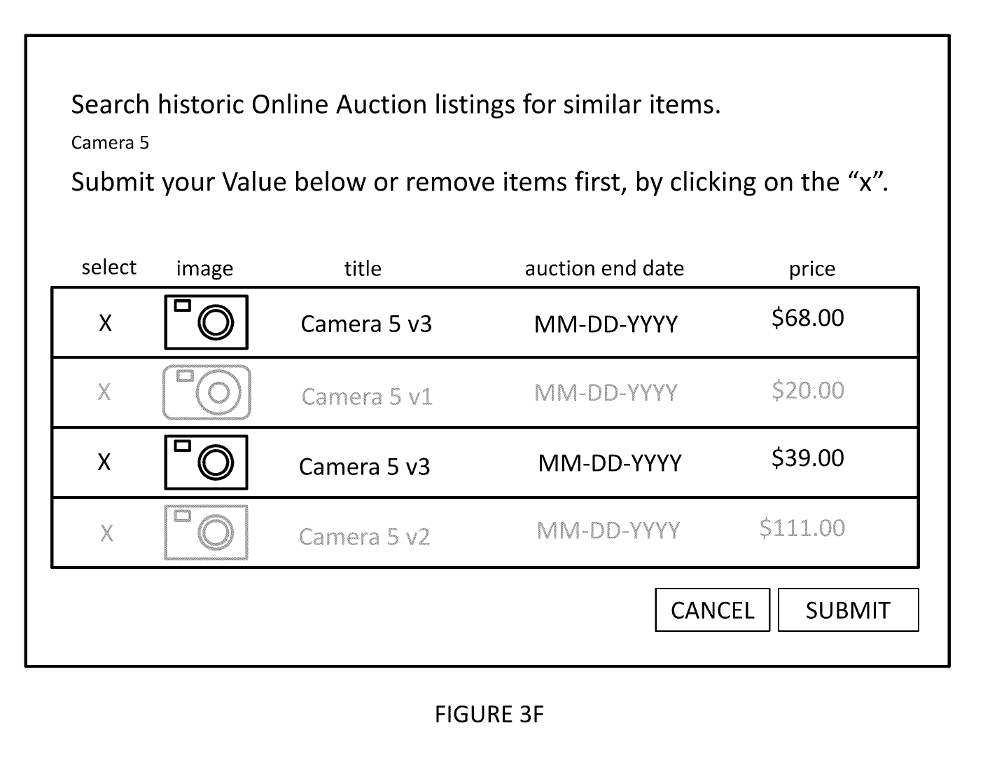

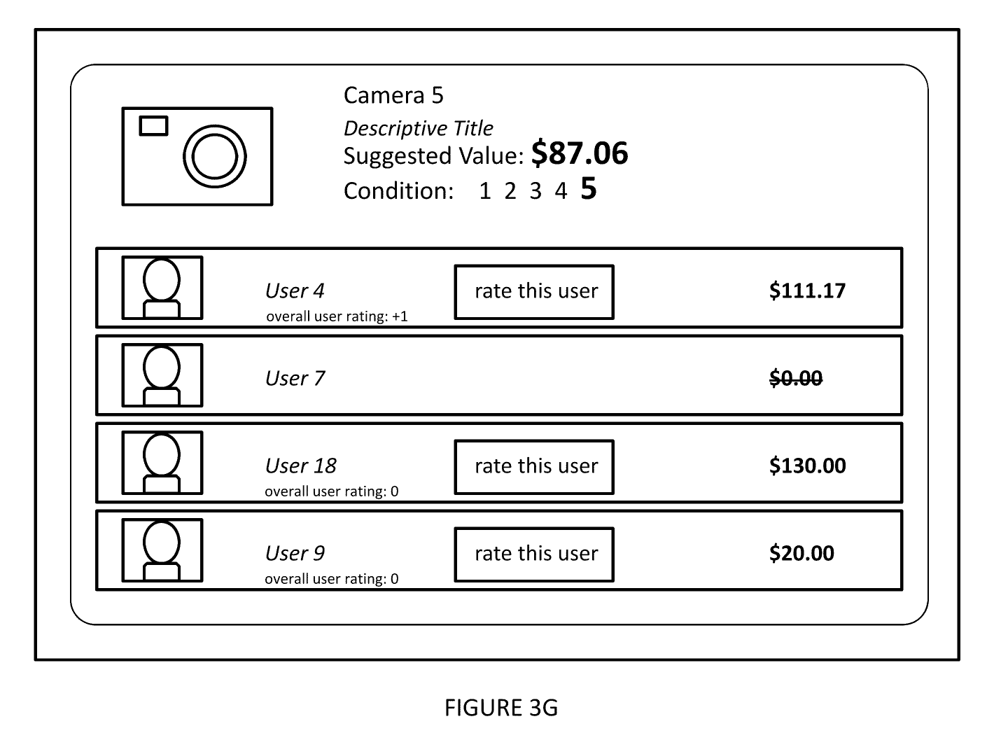

As shown in FIG. 3A, the step of searching for a product includes the steps of entering a product description into a search bar and clicking on the search button. The step of searching for a product may alternatively include the steps of entering categories and subcategories to “narrow in” on the desired product. As shown in FIG. 3B, the step of providing search results preferably includes the step of providing a list of relevant products along with a photo of the product and a brief description and/or title of the product. As shown in the left hand corner of FIG. 3B, the search results may be filtered based on the attributes of the products. Product attributes preferably include brand, model, size, storage capacity, mega pixels, etc. As shown in FIG. 3C, a user may select a product from the list of search results. The system preferably provides product data on this product such as average price, price of the item when new, where to buy the buy product, where to buy the item on internet marketplaces such as eBay, product specifications, product reviews, the values of other users' similar products, and/or any other suitable information.

The step of creating a product value request may be completed from scratch by entering information on the product directly or may be completed by customizing a product selected from the product search results. As shown in FIG. 3D, the step of creating a product value request preferably includes the steps of entering the title of the product, specifying the condition of the product, entering a description of the product, and/or uploading photos of the product. The step of specifying the condition of the product preferably includes the step of giving a rating on a scale of 1 to 5, but may alternatively include any other suitable means of specifying the condition. For example, a product in poor condition with a broken screen and several scratches may be given a 1 while a product that is new or just out of the box and as good as new might be given a 5. The step of entering a description of the product includes entering information on the condition of the product, accessories or extras included with the product, length of use of product, age of product, and/or any other suitable information on the product. By creating a product value request, a user is creating a location or portal, where other users may enter information on the product. The information preferably includes a user estimated value, user submitted value from a marketplace listing, a user submitted value from an external site, a comment on the quality or condition of the product or similar products, or any other suitable information.

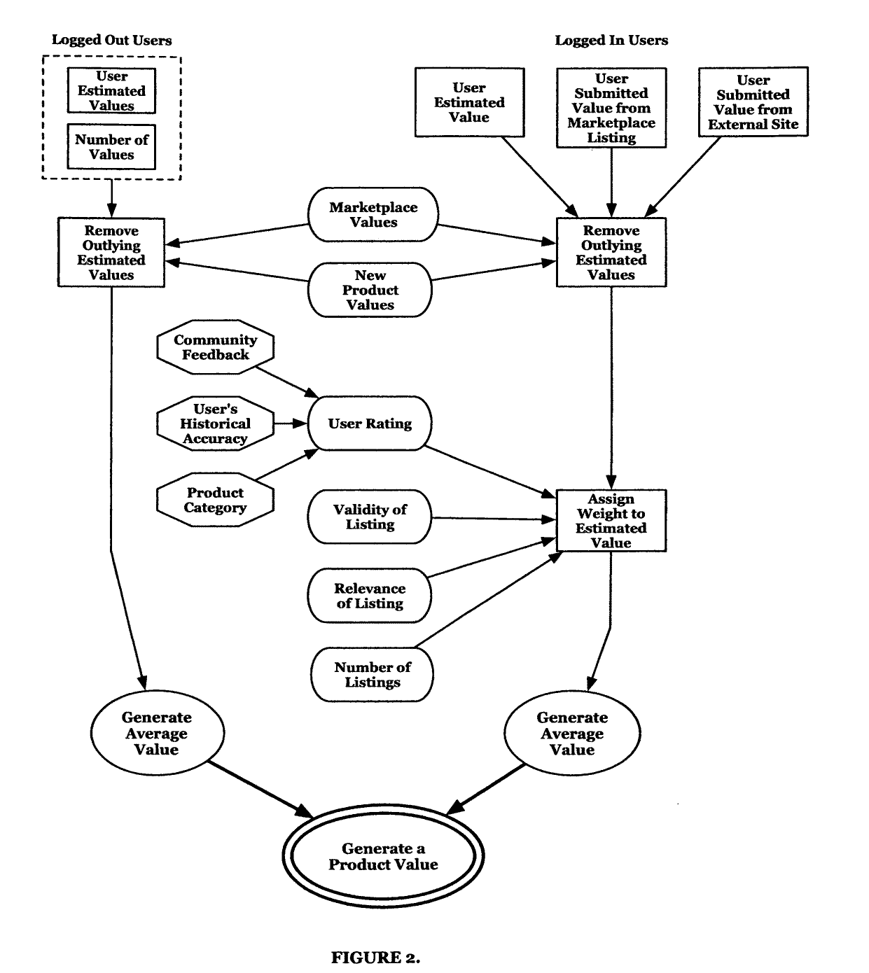

As shown in FIG. 2, the step of generating a product value includes the steps of receiving information from multiple sources, removing outlying values, assigning weights to values, generating an average value, and generating a product value. As shown in FIGS. 2 and 3E, the step of receiving information from multiple sources includes the steps of receiving a user estimated value from a user that is not logged into the system (“Widget” in FIG. 3E), receiving a user estimated value (“Estimate” in FIG. 3E), receiving a user submitted value from a marketplace listing (“eBay” in FIG. 3E), and receiving a user submitted value from an external site (“Link” in FIG. 3E). The step of receiving a user estimated value from a user that is not logged into the system includes the step of posting a product value request onto an external site and collecting the user estimated values that are entered into the product value request on the external site. The product value request on the external site is preferably an e-mail, a widget, or any other suitable product value request on any suitable external site. The external site is preferably a blog, social networking page such as Facebook, MySpace, and/or Bebo, a classifieds site such as Craigslist, or any other suitable external site. As shown within the dotted line in FIG. 2, the product value request on the external site collects an estimated value from each user and sends and/or provides data to the system. The data includes the estimated values and the number of estimated values received.

As shown in FIG. 2, the system receives values from users that are logged into the system by receiving a user estimated value, receiving a user submitted value from a marketplace listing, and/or receiving a user submitted value from an external site. A user estimated value is provided by a user entering an estimate of the value of the product. A user submitted value from a marketplace listing is provided by a user submitting one or more values of the product from historic marketplace listings. For example, as shown in FIG. 3F, the system will access data on recent sales from a marketplace, such as eBay or any other suitable marketplace. The system will provide a user with a photo of the product, the title of the product, when the product was sold, how much the product was sold for, and/or any other suitable information. As shown in FIG. 3F, the system allows the user to select the relevant marketplace listings (shown in black) and/or remove the irrelevant and/or undesirable listings (shown in gray). The average price of marketplace listings will be calculated based on the user selected marketplace listings. A user submitted value from an external site is provided by a user submitting one or more values of the product that originate from an external site and/or listing. The external site is preferably a classifieds listing site such as Craigslist, an ecommerce or retail site such as Amazon, a marketplace such as eBay or Facebook, and/or any other suitable site. In the submission of the value, the user preferably provides the value of the product from the site, the link to the product on the site, and any other suitable information.

As shown in FIG. 2, the step of removing outlying values functions to remove unreasonable and/or incorrect values before they are included in the generation of the product value. An outlying value is a value that is either too low or too high to be included in the generation of the product value. A value is determined to be too low or too high based on several factors. The factors preferably include factors such as marketplace values (i.e. what this product has sold for in the past in marketplaces such as eBay, etc.), the value of the product when the product is new, whether this product appreciates or depreciates, and/or any other suitable factor. For example, as shown in FIG. 3G, a value of $0.00 given to a digital camera would be considered too low and therefore an outlier and would be removed (for example, shown as “$0.00”) and not included in the generation of the product value.

As shown in FIG. 2, the step of assigning weights to values functions to differentiate between different values and to assign a higher weight to some values and a lower weight to other values. Values assigned a higher weight will play a larger role in the generation of the product value than a value that has been assigned a lower weight. The weighting of a value is determined by several factors. Those factors preferably include the rating of a user, the relevance of a listing, the number of listings, the validity of the listing, and/or any other suitable factor.

For example, a user estimated value is provided by a user entering an estimate of the value of the product. The value entered by the user will be weighted according to the rating that that user has. If the user has a very high rating, the value entered by that user will receive a high weighting and will play a larger role in the generation of the product value. A user receives a rating based on the feedback from other users in the system, their historical accuracy, the product category, the number of estimates the user has given, and/or any other suitable factors. The other users in the system will give feedback to the user and/or change the user's rating based on their perceived accuracy of the estimated value and/or the accuracy of estimated values this user has given in the past. The historical accuracy of a user depends on how accurate their estimated values have been for other products in the past. The historical estimated value is preferably compared to the sale price of the item once the item sells and the accuracy of that historical estimated value contributes to the user's rating. A user may also have a higher rating in a specific product category. For example, if the user is an expert on road biking equipment but has never golfed before, their rating within a biking equipment category will be higher than their rating within a golf equipment category.

In another example, a user submitted value from a marketplace listing is provided by a user submitting one or more values of the product from historic marketplace listings. The value submitted by the user will be weighted according to the rating that that user has, the relevance of the listings, and the number of the listings. The relevance of the listings depends on how closely the products in the listings match the product for which the value is to be generated. The higher the relevance of the listings, the higher the weight that the average price of the listings will receive and the larger the roll this value will play in the generation of the product value. Additionally, the higher the number of relevant listings provided, the higher the weight that the average price of the relevant listing will receive and the larger the roll this value will play in the generation of the product value. In yet another example, a user submitted value from an external site is provided by a user submitting one or more values of the product that originate from an external site and/or listing. The value submitted by the user will be weighted according to the rating that that user has and the validity of the listing. The validity of the listing depends on the validity of the external site and/or any other suitable factors.

As shown in FIG. 2, once the outliers have been removed and the weightings have been assigned, an average value is generated taking into account all (or any suitable combination) of the considerations described above. As shown in FIG. 3G, the step of generating an average value functions to provide at least one average value generated via one of the steps of receiving a user estimated value (logged on or off), receiving a user submitted value from a marketplace listing, and/or receiving a user submitted value from an external site. As shown in FIG. 3G, user jordan” has provided information to generate an average value of $111.17. As shown, this value was generated as a user submitted value from a marketplace listing (shown as “Method: eBay”). User “jordan” has a user rating of +1. User “pkobert” has provided information to generate an average value of $0.00 and this value has been determined to be an outlier (too low) and has been removed. As shown, this value was generated as a user estimated value from a user (or group of users) not logged into the system (shown as “Method: Widget”). User “JessicaC” has provided information to generate average values of both $130.00 and $20.00. As shown, these values were generated as a user estimated value (shown as “Method: Estimate”) and a user submitted value from an external site (shown as “Method: Link”), respectively. As described above all of the submitted/received information has been either removed or weighted to create the average values.

As shown in FIG. 2, the step of generating a product value functions to bring together the series of average values into a single value. For example, as shown in FIG. 3G, the system has generated a product value of $87.06 for a casio compact digital camera. This product value have been generated from the average values of $111.17, $130.00, and $20.00 which were generated as a user submitted value from a marketplace listing, a user estimated value, and a user submitted value from an external site, respectively. Each of the average values are preferably weighted based on the method used to obtain this data, the user's rating, the number of averages generated, and/or any other suitable factors. Each of the weighted average values is then combined to generate the product value.

As shown in FIG. 1B, the steps of receiving a product value and then creating a product listing function to allow a user to easily sell their product based on the generated product value. For example, based on the generated product value from the system, the user may decide that their product is valuable and that they wish to sell their item. The system provides a mechanism with which a user may easily create a product listing with which to sell their item in a marketplace, such as eBay, or in any other suitable location.

Although omitted for conciseness, the preferred embodiments include every combination and permutation of the various product values requests and the various steps and combinations of steps of creating a product value request and generating a product value.

As a person skilled in the art will recognize from the previous detailed description and from the figures and claims, modifications and changes can be made to the preferred embodiments of the invention without departing from the scope of this invention defined in the following claims.

I claim:

1. A method for generating a product value, the method comprising:
receiving a product value request from a user;
providing a product value information portal;
accumulating product value information; and
generating a product value.

2. The method of claim 1, the receiving step comprising receiving a product value request from a user by the user selecting a product from a list of search results.

3. The method of claim 1, the receiving step further comprising receiving information about the product.

4. The method of claim 3, wherein the information about the product includes at least one of the title of the product, the condition of the product, a description of the product, and photos of the product.

5. The method of claim 1, the accumulating step comprising receiving a user estimated value.

6. The method of claim 5, wherein the user estimated value is a value received from a user that is not logged into the system.

7. The method of claim 6, wherein the step of receiving a user estimated value from a user that is not logged into the system comprises the step of collecting user estimated values that are entered into an external system.

8. The method of claim 1, the accumulating step comprising receiving a value from a marketplace listing.

9. The method of claim 8, wherein the value from a marketplace listing is a value that the product sold for in an historic marketplace listing.

10. The method of claim 9, wherein the step of receiving a value from a marketplace listing comprises the steps of providing multiple marketplace values to a user and receiving selected marketplace values from a user.

11. The method of claim 10, wherein the step of receiving a value from a marketplace listing further comprises calculating an average marketplace value based on the marketplace values selected by the user.

12. The method of claim 1, the accumulating step comprising receiving a value from an external site.

13. The method of claim 1, the generating step further comprising removing outlying values.

14. The method of claim 13, the step of removing outlying values comprising removing a value that is outside of a predetermined range.

15. The method of claim 1, the generating step further comprising multiplying a value by a constant.

16. The method of claim 15, wherein the value of the constant is determined by the validity of the source of the value.

17. The method of claim 16, wherein the source of the value is a user, and the validity of the user is determined by factoring in at least one of feedback on the user from other users in the system, historical accuracy of the user, product category, and number of estimates the user has submitted to the system.

18. The method of claim 1, the generating step further comprising generating an average value.

19. The method of claim 1, further comprising the step of creating a marketplace listing.

20. A system for generating a product value, the method comprising:
a user interface adapted and configured to receive a product value request from a user for a specified product;
a portal adapted and configured to receive value information from a plurality of users for the specified product; and
a processor adapted and configured to accumulate product value information and generate a product value.
